(19) United States
(12) Patent Application Publication
(10) Pub. No.: US 2009/0037236 A1
(43) Pub. Date: Feb. 5, 2009

(54) ANALYTICAL REPORTING AND DATA MART ARCHITECTURE FOR PUBLIC ORGANIZATIONS

(75) Inventors: Mark MILLER, Pleasanton, CA (US); Maria Ana Santiago, Livermore, CA (US); Irving Chin, Dublin, CA (US); James Lee, Mahwah, NJ (US); Judy Krawec, Pleasanton, CA (US)

Correspondence Address: TOWNSEND AND TOWNSEND AND CREW LLP, TWO EMBARCADERO CENTER, 8TH FLOOR, SAN FRANCISCO, CA, 94111-3834, US

(73) Assignee: Oracle International Corporation, Redwood Shores, CA (US)

(21) Appl. No.: 11/831,103

(22) Filed: Jul. 31, 2007

(51) Int. Cl. G06F 17/30; G06F 17/40; G06F 3/048; G06Q 99/00

(52) U.S. Cl. 705/7; 705/1; 715/769

(57) ABSTRACT

A data management architecture for a public institution such as a university is able to extract, transform, and load fact data from disparate data sources and store the information in appropriate data marts. The fact data is correlated with corresponding dimension data, and is correlated with various metrics of a data model, the metrics defined to be useful to the institution. A reporting tool provides user-selectable objects for each metric whereby a user simply selects an object and adds the object to a report in order to automatically generate reports using data from multiple data systems without any manual calculations or reporting by the user. The metrics and data marts can include information for such needs as grants management, financial aid management, admissions, and recruiting. The data marts also can store data over time to provide historical information that may not otherwise be available from the data sources.

### COPYRIGHT NOTICE

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BACKGROUND OF THE INVENTION

The present invention relates generally to the management, analysis, and reporting of data across disparate data sources, and more particularly to systems useful for universities and other public organizations to analyze and report on pertinent information using data from these multiple sources.

In public organizations such as colleges and universities, there are a number of systems used to store and retrieve information for purposes such as financial aid, grants, admissions, and maintaining current student information. Typically these are transactional systems that are very good at receiving, storing, and retrieving such information. For example, FIG. 1 illustrates typical components of a data network 100 for a university, which includes separate data source systems such as a grant management system 114, financial aid management system 106, and student records system 110, connected by an appropriate network 102 such as an intranet or the Internet. Each of these components has a respective data store or data warehouse 116, 108, 112, which typically are maintained separately and have different data structures, etc. A user wishing to access data from these data stores typically uses a computer or terminal 104 to access the various sources over the network 102.

There are various deficiencies in using such systems, however. For example, since the data typically is maintained in separate repositories for each system, an accurate overall picture across the entire data network is not easily obtained. Further, because these are typically separate and disparate systems, there is no way to automatically generate reports including information from different repositories without manually obtaining the information, such as by querying the appropriate source system and downloading the information into a spreadsheet set up by the user, then manually generating a report. It can be difficult for a user to know which data to extract, as the data may be stored using codes or field names that may not be readily identifiable, and each system may use different such codes.

Further still, these systems typically maintain information for current students and financial conditions. It may not be possible, or at least easy, to obtain trending and historical reporting for any of the various systems, let alone historical reporting across multiple disparate systems.

It therefore is desirable to provide a tool that is able to automatically combine data from various disparate source systems in a way that is useful and easily understood by the intended user.

It further is desirable to provide an analytical tool with various metrics that can simply be selected or added to a report in order to easily generate reports that are useful for the organization.

It further is desirable to provide a way to store data over time and easily analyze that data in order to provide for trending and historical information.

It further is desirable to be able to correlate the information from the various source systems with field names that can easily be understood by the user.

It further is desirable to be able to provide a tool, analytics, and a data model for managing both pre- and post-award administration for various grants, including pulling financial and student information from other data sources.

It further is desirable to be able to provide a tool, analytics, and a data model for managing recruiting information for past, current, and potential recruits, including pulling financial and student information from other data sources.

It further is desirable to be able to provide a tool, analytics, and a data model for managing record information for past and current students, including pulling financial and student information from other data sources.

### BRIEF SUMMARY OF THE INVENTION

Systems and methods in accordance with various embodiments of the present invention allow a user to easily generate reports from multiple data sources without any manual calculations or report generation on the part of the user.

In one embodiment, a three-layer architecture is used to provide the reporting capability. In a physical layer, multiple data marts can be defined such that fact data can be extracted, transformed, and stored into an appropriate data mart. The data can come from multiple data sources, such as a grant data source, a financial aid data source, a student record data source, a recruiting data source, and an admissions data source. These data sources can includes disparate sources that are otherwise unable to communicate with each other. The data marts are capable of storing the fact data over time, such that trending and historical analysis is possible even if the fact data is not stored over time by the respective data source(s).

A modeling layer is built on top of the physical layer. The modeling layer includes a metadata component operable to correlate the fact data and dimension data with various metrics. The metrics are defined to provide information that is useful to the user and may combine information from multiple data sources. Metrics can include, for example, metrics for class meeting pattern analysis, grants management, flexible cohorts analysis, successful student prediction, and principle investigator performance.

A presentation layer is built on top of the modeling layer. The reporting layer includes an analytic tool operable to present user-selectable objects to a system user, each object corresponding to a metric in the modeling layer. A user can select an object, such as by dragging the object onto a report page, whereby the analytic tool automatically extracts the pertinent information from the appropriate data mart(s) and performs any necessary calculations or trending in order to automatically generate the report for the user.

A further understanding of the nature and the advantages of the inventions disclosed herein may be realized by reference of the remaining portions of the specification and the attached drawings.

### BRIEF DESCRIPTION OF THE DRAWINGS

Various embodiments in accordance with the present invention will be described with reference to the drawings, in which:

FIG. 1 illustrates typical components of a university data network of the prior art;

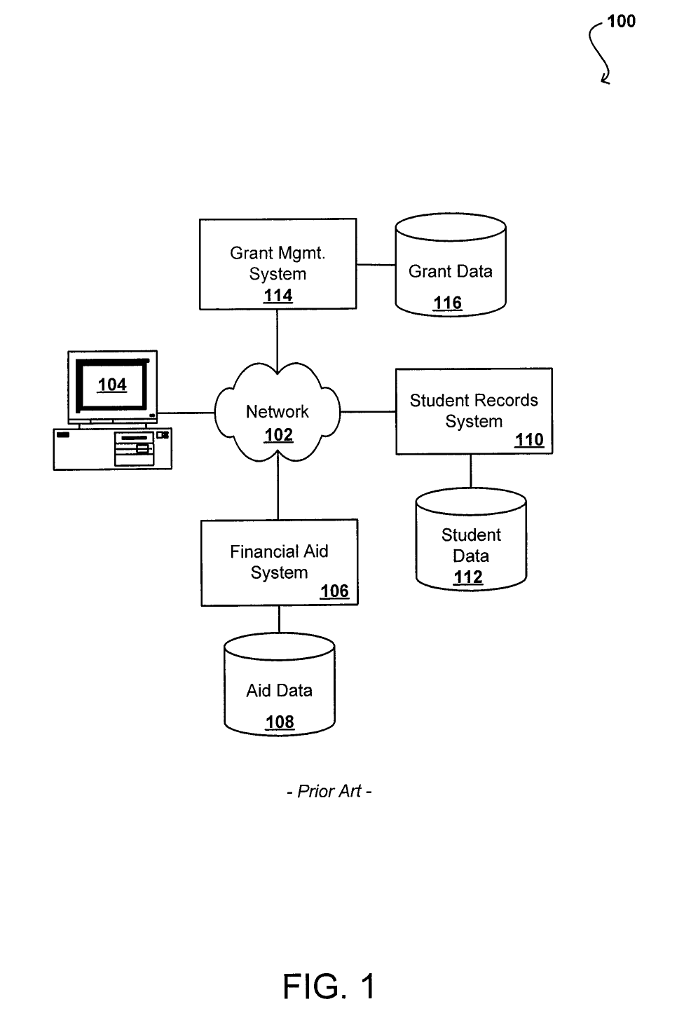

FIG. 2 illustrates an architecture in accordance with one embodiment of the present invention that can be used with a system such as that shown in FIG. 1;

FIG. 3 illustrates steps of an process that can be used in accordance with one embodiment of the present invention;

FIG. 4 illustrates components of an exemplary operating environment that can be used in accordance with various embodiments of the present invention; and

FIG. 5 illustrates components of an exemplary computer system that can be used in accordance with various embodiments of the present invention.

### DETAILED DESCRIPTION OF THE INVENTION

Systems and methods in accordance with various embodiments can overcome the aforementioned and other deficiencies in asset management and tracking systems by providing an architecture and various metrics that allow users to easily generate reports by selecting specific reporting objects. Exemplary objects can be used in a presentation layer to automatically pull correlated data from at least one data mart storing data from various systems, such that a user can easily generate reports using network-wide data by selecting the desired objects. In one embodiment, this is as simple as dragging visual objects onto a report page and arranging the objects in an appropriate manner.

A common data model can be used that includes various analytics, and that can account for historical information. Transactional data can be pulled from the various data sources, which cannot otherwise communicate with each other, and can be stored in a data warehouse and appropriate data mart(s). The data marts can be built using dimensional modeling, star schemas, and other appropriate technologies known or used in the art. The data from the various sources is extracted, manipulated, transformed, and loaded into tables of the data mart(s). The data marts can be used to store historical information that might not otherwise be stored or maintained in the source systems, such that trending an analysis can be possible that would not otherwise be available.

An analytic tool such as Oracle Business Intelligence Enterprise Edition (OBIEE) available from Oracle Corporation of Redwood Shores, Calif., can be built on top of the data warehouse. The analytic tool can be used to further simplify the data for the end users, such as by using metadata to describe the data in a way that users can easily understand. A reporting tool then can allow users to easily generate reports that otherwise would not be available as there is no commonality across the source systems. There is no automated way to pull all appropriate data from the various systems and combine, analyze, trend, and perform other functions without a substantial amount of tedious manual work.

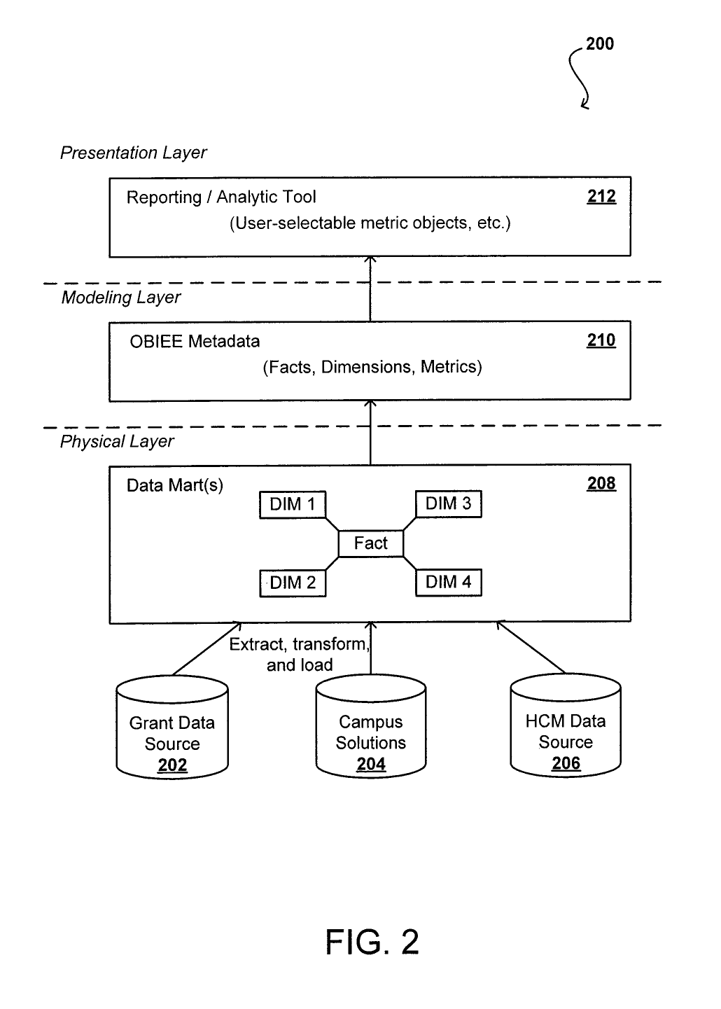

FIG. 2 shows an exemplary architecture 200 that can be used to provide functionality in accordance with various embodiments of the present invention. This exemplary architecture is modeled upon three basic layers: a physical layer, a modeling layer, and a presentation layer. The physical layer includes the various data sources storing data used for reporting and analysis. In this example, these data sources include a grant data source 202, campus solutions data source 204, and human capital management (HCM) data source 206. There are numerous other systems, such as human resources systems, financial systems, purchasing systems, capital management systems, etc., that can be used with the various embodiments. These data sources can be maintained separately and may not be able to communicate with one another.

The system includes a data warehouse in the physical layer that includes one or more data marts 208. The data warehouse can extract data from the various data sources, transform the extracted data as needed, and can load the transformed data into the appropriate data mart 208. The data coming from the various sources can be considered to be “fact” data, such as a list of student identifiers where the corresponding student is currently receiving financial aid. Each fact in the data mart is surrounded by, or related to, various dimensions or instances of dimensional data. An example of dimensional data is the identity of the particular student having a student ID listed in the financial aid table.

The fact data stored in the data mart can reflect anything related to information that the organization or entity might want to track. In the case of grants, for example, fact data can include information such as payment information, disbursements, and remaining balance for a given grant. The grant-related transactions can be captured and modeled as facts in the appropriate data mart. On the campus side, facts can include information such as student report card data, student tuition payments, and student application data. Each of these example facts may be desirable to track, and the data mart can accumulate this information historically over time such that trending and other analysis is available to the user. The facts in the data mart(s) can be uniquely mapped and designed on top of facts in the various source systems.

A modeling layer then can be built upon the physical layer. The modeling layer can include a metadata component 210 such as an OBIEE component, referenced above, that can include a set of metrics or key performance indicators (KPIs) useful for the organization and reports generated thereby. Each metric in the metadata component has a specific piece of logic that utilizes the data structures of the data marts to address the various metrics being reported. The various metrics can be determined ahead of time, and can be updated over time, in order to address the various needs of organizations and entities using the architecture. By combining fact and dimension data with metadata at the modeling layer, a person doing a report does not have to know how to join data fields or sources, as the joining is already done using the appropriate metric and portion of the business model. Similarly, all the measurement/KPI information is included at this business modeling layer. The logic can be based on existing functions, such as average, count, sum, etc., built on top of the business modeling layer data.

An example of a metric that can be coded and stored in the modeling layer is a metric that associates and/or tracks the number of students receiving financial aid, as extracted from the financial aid data source, who also were awarded grants, as extracted from the grants data source. A count of such students can be maintained in the modeling layer, or a mapping or correlation can be kept in the layer such that a user can easily extract the information from the appropriate data mart(s). Providing such a metric is not only beneficial because a user can simply select the appropriate object to add to a report, but it would be otherwise difficult to determine the information because the grant and financial aid information is maintained separately, and there is no way to automatically generate such a report or easily reconcile such information. There also is no way to trend such information historically using existing systems.

A reporting and analytic tool 212 then can be built on top of the metadata component 210 in order to allow users to view selected via reports and analytics at a presentation layer. An analytic tool in the presentation layer can present each of the measures and KPIs in user-friendly terms that can easily be understood and selected. For example, instead of a field name such as App_No, the field can be correlated with dimension data and presented to the user as an “Application Number” field, for example. The tool also can be used to work with the metadata component to create and shape the metadata layer.

For an example regarding a college application, an applicant applying to a university can have various information associated with that application, and the data source storing that information will include various codes for the data fields, such as codes for the various majors available, codes for the various colleges within the university, etc. An important piece of information for reporting purposes might be the students financial aid (e.g., FAFSA) number that the student received when applying for financial aid. These codes then relate to various dimensions that would be pulled in from the appropriate data source, such as a Campus Solutions database. The joining of a major code with a major dimension on the reporting side makes it very easy for someone to see the actual major selected, such as “Aerospace Administration,” instead of just seeing the corresponding code, such as “AA,” which could stand for other majors such as “Accounting—Audit,” etc. By joining the dimension and the fact data into a single, easy to understand format, users can quickly and easily select data and generate reports that are instantly useful for the organization. By understanding the needs of the organization and incorporating these needs as logic within the business model at the modeling layer, organizations can easily obtain the necessary trending and reporting information needed with minimal operator time or experience needed.

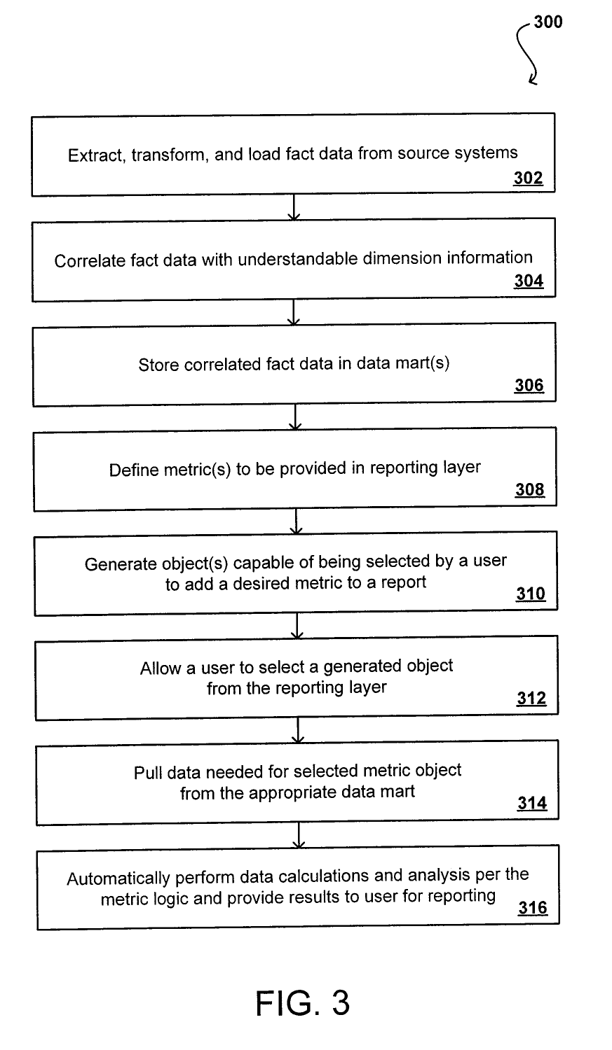

An exemplary process 300 for using such a system will be described with respect to FIG. 3. For purposes of this example, a university might want to track a measure such as the number of applicants of nationality “A” receiving financial aid. Instead of pulling information from the various data sources and manually generating a report, it can be desirable to build a KPI into the business model that will define that logic in the modeling layer. For example, fact data relevant to the metric, such as the student nationality information from a student information data source and the student financial aid information from a financial aid data source can be extracted and transformed as necessary 302. The fact data can be correlated with appropriate dimension data 304, such as a student name instead of a student identifier, and can be stored in an appropriate data mart 306. The fact data can also be correlated in the data model, and a metric can be defined 308 for easy viewing or inclusion in a report. In this example, the data model can include logic for a metric such as “Applicants_Nationality_A_Receiving_Aid”. The metric will include the necessary underlying logic, and can have associated therewith a field or have a selectable object generated 310 such that if a user selects to add this metric to a report, the user simply selects that object from the reporting layer 312, such as by “dragging” the object onto a report page. Once the object is pulled onto the page, the reporting tool can automatically pull the data needed for the selected metric from the appropriate data mart 314, and can perform any calculations or analysis to generate the results to be presented to the user 316. The report then can automatically show the data with any calculations and correlations already done.

The following sections present examples of components and aspects that can be used with various embodiments.

### Grants Data Mart

In the case of a data mart for handling grants, grants information can be collected in a centralized repository and in a format that is easily reported from. A grant data mart can fulfill this need by employing a custom data model along with the necessary functionality to load the model. As universities and public sector organizations need the ability to track the status of the grants for which they apply and which they award, it is desirable to be able to easily determine the point in the process where each grant resides, as well as much of each grant has been spent and how much remains as a balance. It further is desirable to be able to quickly view summaries of the various grants awarded or received in order to compare to budgets and forecasts, for example. Further, it is desirable to be able to present this functionality in an at-a-glance manner that allows high level administrators access to this information in a simple, easy to understand manner. Such a solution facilitates ubiquitous availability of grant information to any type of consumer. Prior solutions, which would have involved spreadsheets and the like, would not have the advantage of ease of use or the ability to share. Such a solution also helps public organizations to manage the very costly (or lucrative) process of grant awarding and application. Such a solution allows grants administrators and executives to obtain detailed as well as summary information, as well as to identify situations that need immediate attention, such as when grant money is about to run out.

### Admissions and Recruiting Data Mart

A solution for admissions and recruiting can include a data mart that collects the admissions and recruiting information in a centralized repository in an easily accessible format. Such a solution can fulfill this need by employing a custom data model along with functionality necessary or useful to load the model. Institutions such as universities need to be able to generate and view analytics around recruiting information in order to provide information about prospects and recruits for the institution, the institution's success in converting recruits to applicants and enrollees, and the eventual student lifecycle records at the institution. Institutions also need to be able to generate and view admissions reports in order to provide information about applicants to the institution, and perhaps those students' eventual records at the institution. Metrics thus can include year-to-year comparisons of such data for trending and comparative analysis. As universities compete harder to attract and retain students than ever before, an admissions and recruiting data mart can give universities competitive advantage because the universities will be able to learn from past mistakes and understand trends in order to meet demand and take advantage of opportunities for improvement.

### Financial Aid Data Mart

A financial aid data mart can be used to collect student financial aid information in a centralized repository in an easily-accessible format. Such a solution can fulfill this need by employing a custom data model along with functionality necessary or useful to load the model. Institutions such as universities need to be able to generate and view analytics around the various student financial components. Financial Aid is a key area, and analytics centered around the Financial Aid awards are required, as well as around the disbursement of award money. Users need to be able to track awards that have been granted and then be able to track the disbursements across a variety of dimensions, including award type, income level, ethnicity, etc. Student financials is another key area, with analytics covering student payments, applicant fees, etc., being necessary. The ability to tie the student financials to the financial aid is key as well. Finally, university-wide financial reporting and analytics are required to determine the financial health of the organization. Present solutions do not collect all this information into one data source, in a form that is readily accessible to all consumers. Universities must be able to track and analyze the various financial components of their institutions, including financial aid, student fees and payments, and general ledger-based financial information, and such a solution gives them the ability to do this by consolidating the data into one mart where the data can be accessed by anyone, summarized, linked, compared, trended, etc.

### Student Records Data Mart

A student records data mart can collect student records information in a centralized repository in an easily-accessible format. Such a solution can fulfill this need by employing a custom data model along with functionality necessary or useful to load the model. Universities need to be able to generate and view analytics around student record information. These analytics include such items as enrollment and registration metrics, count of student and faculty by registered courses, available courses for catalog building and schedule building, graduation rates and student career fulfillment of requirements, student academic standing, and faculty and student profiles. Enrollment analytics are critical for most institutions as well, and these include everything from monitoring average class sizes, pre-requisites not being met, grade distributions, and graduation eligibility. Many reports in this category will include aggregated statistical reports, with year to year comparisons with myriad dimensions. Present solutions do not collect all this information into one data source, in a form that is accessible to all consumers. Universities must be able to track and analyze the various metrics around the students they admit in the areas of enrollment and registration, class scheduling, faculty profile, student profile, student academic standing, and graduation rates. Such a solution gives universities the ability to do this by consolidating the data into one mart where the data can be accessed by anyone, summarized, linked, compared, and trended.

Embodiments discussed herein would be applicable to other products and environments as well in that the data model, and programs that populate the model, can be designed to accommodate any information source.

### Class Meeting Pattern Analysis Data Model

Models such as class meeting pattern analysis data models can demonstrate an understanding of the data structure interdependencies to fulfill a customer's desires to derive information that is not physically or logically stored in the database. For years customers have struggled to find out which classes were offered in a particular academic period, but did not materialize into an actual class session during the period. Customers would need to generate list reports and queries against the database to find all class offerings and compare against alternately generated reports with class sessions that were instantiated after an enrollment process. With the Class Meeting pattern analysis data model designs, customers have access to a single place to find such KPIs (e.g., class offerings, class sessions, class offered but no session created) that would help create more effective class offerings in future academic periods. One differentiator is that through a combination of data model design and business intelligence tool enablement, customers can obtain a unique information delivery experience that presents all the information and correlations.

### Grants Management Data Model

Customers can use custom delivered offerings and vendor provided offerings that give insight into the grants management process, from proposal creation, to award administration, to encumbrance accounting, and through financials. Customers can receive all this information on a summarized basis, as an exemplary solution offers detailed analysis leveraging knowledge of underlying integration links between transaction systems across a product inventory. A grants management data model can contain metrics down to detailed components in encumbrances accounting reporting. An example includes analyzing the month to date HR tax expense, as well as HR benefits expense encumbered to a specific grant. Such a solution requires an understanding of the integrations between payroll products and general ledger products, for example.

### Cohorts Analysis Data Model

Understanding the complex user definable nature of the appropriate source system(s) is necessary to create reports against a user defined cohort group. Present solutions typically predefine a cohort group, but a solution in accordance with one embodiment delivers a flexible construct to emulate the user-defined nature of the cohort definition capabilities of the source system. Such a solution allows for analysis not only against generic student attributes (e.g., age and academic level) but also for a user defined cohort group for base system metrics (e.g., student count).

### Successful Student Data Model

A successful student data model can be used to detect “successful” students, providing institutions with the data (and history) to discover and access student profiles. The detection of “successful student” is key for universities, as universities want to be able to focus recruitment efforts on students most likely to succeed at the institution based on past performance, etc.

### Additional Grants Proposal and Management Data Model

There are many types of analysis useful (and unique) for grants proposal and management. A common requirement is related to principal investigator (“PI”) analysis. Principal investigators get raises and promotions based on their success rate (e.g., the number of proposals awarded versus the number of submitted proposals). Such a solution allows principal investigators to analyze proposals and awards, analyze current status and success rates, and compare this information with historical information, and principal investigator “benchmark” figures if possible, so that a performance of the investigators can easily be determined.

### Other KPI Examples

Other examples of KPIs that can be used with systems, methods, and tools described herein include a KPI for average GPA and test scores for students within a given recruiter's caseload. Another exemplary KPI includes the number or percentage of students by admission status who attended a particular event or camp. Various other examples would be apparent to one of ordinary skill in the art in light of the teachings and suggestions contained herein.

### Exemplary Operating Environment

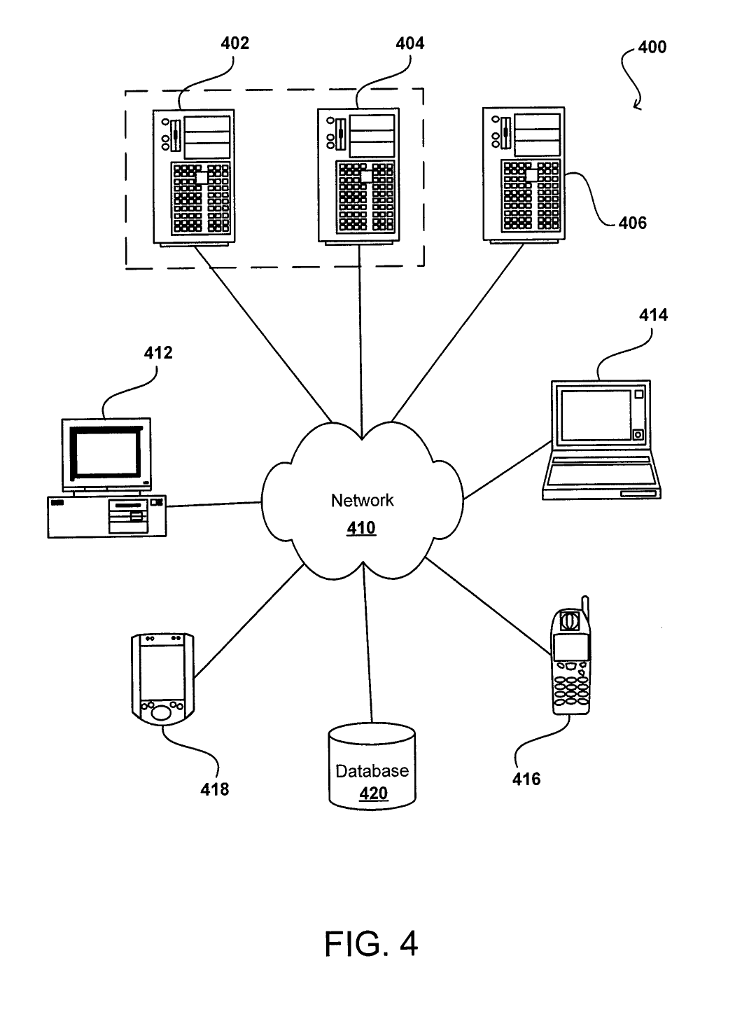

FIG. 4 is a block diagram illustrating components of an exemplary operating environment in which various embodiments of the present invention may be implemented. The system 400 can include one or more user computers, computing devices, or processing devices 412, 414, 416, 418, which can be used to operate a client, such as a dedicated application, web browser, etc. The user computers 412, 414, 416, 418 can be general purpose personal computers (including, merely by way of example, personal computers and/or laptop computers running a standard operating system), cell phones or PDAs (running mobile software and being Internet, e-mail, SMS, Blackberry, or other communication protocol enabled), and/or workstation computers running any of a variety of commercially-available UNIX or UNIX-like operating systems (including without limitation, the variety of GNU/Linux operating systems). These user computers 412, 414, 416, 418 may also have any of a variety of applications, including one or more development systems, database client and/or server applications, and Web browser applications. Alternatively, the user computers 412, 414, 416, 418 may be any other electronic device, such as a thin-client computer, Internet-enabled gaming system, and/or personal messaging device, capable of communicating via a network (e.g., the network 410 described below) and/or displaying and navigating Web pages or other types of electronic documents. Although the exemplary system 400 is shown with four user computers, any number of user computers may be supported.

In most embodiments, the system 400 includes some type of network 410. The network may can be any type of network familiar to those skilled in the art that can support data communications using any of a variety of commercially-available protocols, including without limitation TCP/IP, SNA, IPX, AppleTalk, and the like. Merely by way of example, the network 410 can be a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, GRPS, GSM, UMTS, EDGE, 2 G, 2.5 G, 3 G, 4 G, Wimax, WiFi, CDMA 2000, WCDMA, the Bluetooth protocol known in the art, and/or any other wireless protocol); and/or any combination of these and/or other networks.

The system may also include one or more server computers 402, 404, 406 which can be general purpose computers, specialized server computers (including, merely by way of example, PC servers, UNIX servers, mid-range servers, mainframe computers rack-mounted servers, etc.), server farms, server clusters, or any other appropriate arrangement and/or combination. One or more of the servers (e.g., 406) may be dedicated to running applications, such as a business application, a Web server, application server, etc. Such servers may be used to process requests from user computers 412, 414, 416, 418. The applications can also include any number of applications for controlling access to resources of the servers 402, 404, 406.

The Web server can be running an operating system including any of those discussed above, as well as any commercially-available server operating systems. The Web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers 412, 414, 416, 418. As one example, a server may execute one or more Web applications. The Web application may be implemented as one or more scripts or programs written in any programming language, such as Java®, C, C# or C++, and/or any scripting language, such as Perl, Python, or TCL, as well as combinations of any programming/scripting languages. The server(s) may also include database servers, including without limitation those commercially available from Oracle®, Microsoft®, Sybase®, IBM® and the like, which can process requests from database clients running on a user computer 412, 414, 416, 418.

The system 400 may also include one or more databases 420. The database(s) 420 may reside in a variety of locations. By way of example, a database 420 may reside on a storage medium local to (and/or resident in) one or more of the computers 402, 404, 406, 412, 414, 416, 418. Alternatively, it may be remote from any or all of the computers 402, 404, 406, 412, 414, 416, 418, and/or in communication (e.g., via the network 410) with one or more of these. In a particular set of embodiments, the database 420 may reside in a storage-area network (“SAN”) familiar to those skilled in the art. Similarly, any necessary files for performing the functions attributed to the computers 402, 404, 406, 412, 414, 416, 418 may be stored locally on the respective computer and/or remotely, as appropriate. In one set of embodiments, the database 420 may be a relational database, such as Oracle 10g, that is adapted to store, update, and retrieve data in response to SQL-formatted commands.

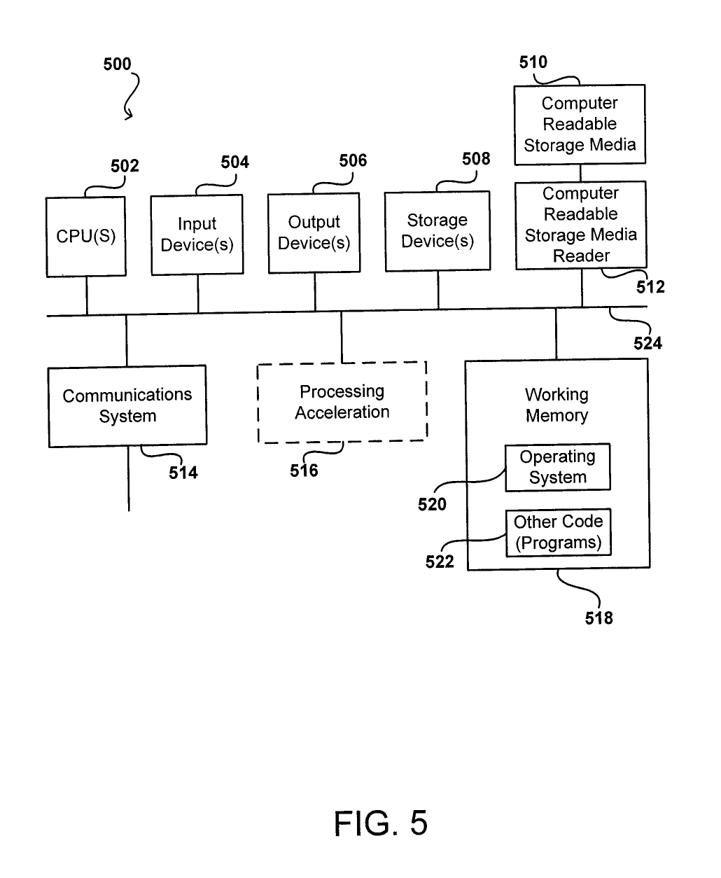

FIG. 5 illustrates an exemplary computer system 500, in which various embodiments of the present invention may be implemented. The system 500 may be used to implement any of the computer systems described above. The computer system 500is shown comprising hardware elements that may be electrically coupled via a bus 524. The hardware elements may include one or more central processing units (CPUs) 502, one or more input devices 504 (e.g., a mouse, a keyboard, etc.), and one or more output devices 506 (e.g., a display device, a printer, etc.). The computer system 500 may also include one or more storage devices 508. By way of example, the storage device(s) 508 can include devices such as disk drives, optical storage devices, solid-state storage device such as a random access memory (“RAM”) and/or a read-only memory (“ROM”), which can be programmable, flash-updateable and/or the like.

The computer system 500 may additionally include a computer-readable storage media reader 512, a communications system 514 (e.g., a modem, a network card (wireless or wired), an infra-red communication device, etc.), and working memory 518, which may include RAM and ROM devices as described above. In some embodiments, the computer system 500 may also include a processing acceleration unit 516, which can include a digital signal processor DSP, a special-purpose processor, and/or the like.

The computer-readable storage media reader 512 can further be connected to a computer-readable storage medium 510, together (and, optionally, in combination with storage device(s) 508) comprehensively representing remote, local, fixed, and/or removable storage devices plus storage media for temporarily and/or more permanently containing, storing, transmitting, and retrieving computer-readable information. The communications system 514 may permit data to be exchanged with the network and/or any other computer described above with respect to the system 500.

The computer system 500 may also comprise software elements, shown as being currently located within a working memory 518, including an operating system 520 and/or other code 522, such as an application program (which may be a client application, Web browser, mid-tier application, RDBMS, etc.). It should be appreciated that alternate embodiments of a computer system 500 may have numerous variations from that described above. For example, customized hardware might also be used and/or particular elements might be implemented in hardware, software (including portable software, such as applets), or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, data signals, data transmissions, or any other medium which can be used to store or transmit the desired information and which can be accessed by the computer. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the invention as set forth in the claims.

What is claimed is:

1. A method of providing reporting objects for an entity, comprising:
providing at least one data mart operable to store data according to a data model including a plurality of metrics useful for reporting for the entity;
extracting fact data from multiple data sources and storing the fact data in the at least one data mart according to the data model, at least two of the multiple data sources being disparate data sources that are unable to communicate information;
correlating the fact data with dimension data allowing a user of the entity to more easily understand the fact data;
providing a user-selectable business object for each metric; and
allowing a user to select a user-selectable business object in order to view at least one of current and historical information for the metric, the viewed information being automatically calculated from the data mart and presented to the user without any manual calculation by the user.

2. A method according to claim 1, further comprising:
storing the fact data in the data mart over time in order to provide for historical trending.

3. A method according to claim 1, wherein:
the multiple data sources include at least one of a grant data source, a student information data source, a campus solutions data source, a financial aid data source, a human resources data source, a human capital management data source, a student records data source, and a recruiting data source.

4. A method according to claim 1, wherein:
the entity is one of a university, college, and public organization.

5. A method according to claim 1, further comprising:
providing a metadata component operable to correlate the fact data, dimension data, and corresponding metrics.

6. A method according to claim 1, wherein:
allowing a user to select a user-selectable business object includes allowing the user to drag the user-selectable business object onto a report page.

7. A method according to claim 1, wherein:
the data model includes a class meeting pattern analysis metric operable to allow a user to determine classes offered for at least one selected academic period and whether the classes actually occurred, wherein the user is able to offer classes in the future that are more likely to be selected by students.

8. A method according to claim 1, wherein:
the data model includes a grants management metric operable to allow a user to determine the current status of a selected grant, wherein a user can determine information such as the application status, payments received, payments disburses, and remaining balance of a selected grant.

9. A method according to claim 1, wherein:
the data model includes a cohorts analysis metric operable to provide a flexible mechanism for defining and reporting on cohort groups using student attributes and system metrics.

10. A method according to claim 1, wherein:
the data model includes a successful student metric operable to provide a user with student performance information in order to allow a user to focus recruiting efforts on students with higher levels of past performance.

11. A method according to claim 1, wherein:
the data model includes a principal investigator metric operable to provide a user with the ability to determine the performance of principal investigators over time.

12. A system for providing reporting objects for an entity, comprising:
a data mart component operable to extracting fact data from multiple data sources and store the fact data in the at least one data mart according to the data mode, the data model including a plurality of metrics useful for reporting for the entity, at least two of the multiple data sources being disparate data sources that are unable to communicate information;
a modeling component operable to correlate the fact data in the data mart component with dimension data, allowing a user of the entity to more easily understand the fact data; and
an analytic tool operable to provide a user-selectable business object for each metric, whereby a user is able to select a user-selectable business object in order to view at least one of current and historical information for the metric, the viewed information being automatically calculated from the data mart and presented to the user without any manual calculation by the user.

13. A system according to claim 12, wherein:
the data mart component is further operable to store the fact data over time in order to provide for historical trending.

14. A system according to claim 12, wherein:
the multiple data sources include at least one of a grant data source, a student information data source, a campus solutions data source, a financial aid data source, a human resources data source, a human capital management data source, a student records data source, and a recruiting data source.

15. A system according to claim 12, wherein:
the data model includes a class meeting pattern analysis metric operable to allow a user to determine classes offered for at least one selected academic period and whether the classes actually occurred, wherein the user is able to offer classes in the future that are more likely to be selected by students.

16. A system according to claim 12, wherein:
the data model includes a grants management metric operable to allow a user to determine the current status of a selected grant, wherein a user can determine information such as the application status, payments received, payments disburses, and remaining balance of a selected grant.

17. A system according to claim 12, wherein:
the data model includes a cohorts analysis metric operable to provide a flexible mechanism for defining and reporting on cohort groups using student attributes and system metrics.

18. A system according to claim 12, wherein:
the data model includes a successful student metric operable to provide a user with student performance information in order to allow a user to focus recruiting efforts on students with higher levels of past performance.

19. A system according to claim 12, wherein:
the data model includes a principal investigator metric operable to provide a user with the ability to determine the performance of principal investigators over time.

20. A computer program product embedded in a computer-readable medium for providing reporting objects for an entity, comprising:
program code for providing at least one data mart operable to store data according to a data model including a plurality of metrics useful for reporting for the entity;
program code for extracting fact data from multiple data sources and storing the fact data in the at least one data mart according to the data model, at least two of the multiple data sources being disparate data sources that are unable to communicate information;
program code for correlating the fact data with dimension data allowing a user of the entity to more easily understand the fact data;
program code for providing a user-selectable business object for each metric; and
program code for allowing a user to select a user-selectable business object in order to view at least one of current and historical information for the metric, the viewed information being automatically calculated from the data mart and presented to the user without any manual calculation by the user.

21. A computer program product according to claim 20, further comprising:
program code for storing the fact data in the data mart over time in order to provide for historical trending.
